(19) United States
(12) Patent Application Publication
(10) Pub. No.: US 2025/0350470 A1
(43) Pub. Date: Nov. 13, 2025

(54) SYSTEMS AND METHODS FOR BLOCKCHAIN-BASED AUHTENTICATION AND FOR NOVELTY DETECTION

(71) Applicant: Daniel Kovach, Tampa, FL (US)

(72) Inventor: Daniel Kovach, Tampa, FL (US)

(21) Appl. No.: 18/641,234

(22) Filed: Apr. 19, 2024

Related U.S. Application Data
(60) Provisional application No. 63/497,188, filed on Apr. 19, 2023.
(60) Provisional application No. 63/497,192, filed on Apr. 19, 2023.

(51) Int. Cl. H04L 9/32; G06K 19/06

(52) U.S. Cl. CPC H04L 9/3239; G06K 19/06187

(57) ABSTRACT

System and methods for physical authentication using blockchain technologies. A user list is encoded via hashes of respective wallet addresses to construct a Merkle Tree. The Merkle Root of the constructed Merkle Tree is recorded on the blockchain. The Merkle Tree and the Merkle Root are updated each time a user is added to the organization. A user is authenticated by submitting a message to the client, which creates a Merkle Proof and sends it to the blockchain for authentication. The process can be facilitated by a mobile application that generates a Quick Response (QR) code representing the user's wallet address.

### CROSS-REFERENCE TO RELATED APPLICATIONS

The present application claims priority to U.S. Prov. App. Ser. No. 63/497,188, filed on Apr. 19, 2023, titled “PHYSICAL AUTHENTICATION WITH BLOCKCHAIN TECHNOLOGIES,” and U.S. Prov. App. Ser. No. 63/497,192, filed on Apr. 19, 2023, titled “SYSTEMS AND METHODS FOR NOVELTY DETECTION,” the entireties of which are incorporated herein by reference for all purposes.

### TECHNICAL FIELD

The present disclosure relates generally to authentication and machine learning (ML) systems, and more particularly to systems and methods for blockchain-based authentication and for novelty detection.

### BACKGROUND

Blockchain technology, a type of distributed ledger technology, has been widely adopted in various fields due to its inherent security and transparency features. It is a decentralized system where transactions are recorded across multiple computers linked in a peer-to-peer network. Each transaction is recorded in a block and linked to the previous block, forming a chain of blocks, hence the name blockchain.

One of the core components of blockchain technology is the use of cryptographic keys. Each participant in the blockchain network has a pair of cryptographic keys: a public one, which is known to everyone in the network, and a private one, which is kept secret by the participant. The private and public keys are mathematically linked such that a message encrypted with one can be decrypted with the other. This feature is used to ensure the authenticity and integrity of transactions in the blockchain network.

Another integral part of blockchain technology is the concept of a wallet address. A wallet address is a public identifier derived from a participant's public cryptographic keys. It is used to identify the participant in the blockchain network and to receive transactions from other participants.

Physical authentication is a process that requires a physical device to gain access to a resource, such as a facility or a website. Common physical authentication mechanisms include ID cards, biometric devices, and two-factor identification via phone. These mechanisms often require the organization to manage user credentials and data, which can pose security risks and operational burdens.

Merkle Trees are a type of data structure used in computer science and cryptography. They are binary trees where each non-terminal node is labeled with a cryptographic hash of the hashes of its two child nodes. The root node of the tree, known as the Merkle Root, is used in validating the hashes that form the tree. Merkle Trees are known for their efficiency in encoding data, reliability, and security features.

Quick Response (QR) codes are a type of matrix barcode that can be scanned using a smartphone or a QR code reader. They are commonly used to store data such as website URLs, contact information, or text. QR codes can be easily generated and read, making them a convenient tool for data transfer in various applications.

Additionally, Natural Language Processing (NLP) is a field of artificial intelligence that focuses on the interaction between computers and humans through natural language. The ultimate objective of NLP is to read, decipher, understand, and make sense of the human language in a valuable way. It involves several tasks such as machine translation, sentiment analysis, named entity recognition, relationship extraction, and topic segmentation, among others.

One of the techniques used in NLP is the use of Deep Neural Networks (DNNs), which are artificial neural networks with multiple layers between the input and output layers. These networks are capable of learning unsupervised from data that is unstructured or unlabeled, making them particularly useful in NLP tasks. A specific type of DNN, known as an autoencoder, is often used for tasks such as anomaly detection. Autoencoders are a type of artificial neural network used for learning efficient encodings of input data. They work by reducing the dimensionality of the input data and then reconstructing the data from this reduced representation.

In the context of NLP, autoencoders can be trained on a set of input vectors, such as Word2Vec representations of financial headlines, to familiarize the network with a specific type of subject matter. The training set dictates the types of subject matter with which the network becomes familiar. The error between the reconstructed vector, or that which is output by the autoencoder, and the input vector is referred to as the “reconstruction error”. This error can be used as a measure of the novelty of a particular vector with respect to a training set.

However, training an autoencoder can be computationally expensive and time-consuming. It often requires offline processing on a server or cluster, which can be costly. Furthermore, once trained, an autoencoder is typically specialized for a specific task and cannot easily be repurposed for other tasks.

Another approach used in NLP is the graph-based approach, where synonyms of words in a given statement are represented by nodes in a graph, connected by relationships. These relationships can encapsulate various observable qualities such as sentiment, subject, or even the novelty of the information in the statement. This approach offers a different perspective on processing natural language data and can be used in conjunction with other NLP techniques.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for physical authentication using blockchain technologies includes encoding a user list via hashes of respective wallet addresses to construct a Merkle Tree. The Merkle Root of the constructed Merkle Tree is recorded on the blockchain. The method also includes updating the Merkle Tree and the Merkle Root each time a user is added to the organization. A user is authenticated by submitting a message to the client, wherein the client creates a Merkle Proof and sends it to the blockchain for authentication.

According to other aspects of the present disclosure, the method may include encoding the user list using a cryptographic hash function, such as a Secure Hash Algorithm (SHA). The method may also include verifying the Merkle Proof using the user's public wallet address. The message submitted by the user for authentication may be encoded using the user's private wallet address. The authentication process may be facilitated by a mobile application that generates a Quick Response (QR) code representing the user's wallet address.

According to another aspect of the present disclosure, a system for physical authentication using blockchain technologies includes a user list encoded via hashes of respective wallet addresses to construct a Merkle Tree. The Merkle Root of the constructed Merkle Tree is recorded on the blockchain. The system also includes a mechanism for updating the Merkle Tree and the Merkle Root each time a user is added to the organization, and a mechanism for authenticating a user by submitting a message to the client, wherein the client creates a Merkle Proof and sends it to the blockchain for authentication.

According to other aspects of the present disclosure, the system may include encoding the user list using a cryptographic hash function, such as a Secure Hash Algorithm (SHA). The system may also include a mechanism for verifying the Merkle Proof using the user's public wallet address. The message submitted by the user for authentication may be encoded using the user's private wallet address. The system may further include a mobile application for facilitating the authentication process, which generates a Quick Response (QR) code representing the user's wallet address.

According to yet another aspect of the present disclosure, a computer-implemented method for physical authentication using blockchain technologies includes encoding a user list via hashes of respective wallet addresses to construct a Merkle Tree. The Merkle Root of the constructed Merkle Tree is recorded on the blockchain. The method also includes updating the Merkle Tree and the Merkle Root each time a user is added to the organization. A user is authenticated by submitting a message to the client, wherein the client creates a Merkle Proof and sends it to the blockchain for authentication.

According to other aspects of the present disclosure, the computer-implemented method may include encoding the user list using a cryptographic hash function, such as a Secure Hash Algorithm (SHA). The method may also include verifying the Merkle Proof using the user's public wallet address. The message submitted by the user for authentication may be encoded using the user's private wallet address. The authentication process may be facilitated by a mobile application that generates a Quick Response (QR) code representing the user's wallet address.

The disclosed technology represents a practical application with technological improvements by enhancing the speed and efficiency of the authentication process. The use of Merkle Trees in the encoding of the user list allows for rapid verification of user credentials without the need to traverse the complete list. This is because Merkle Trees enable a technique known as “hashing” which can confirm the presence of a specific data element within a large dataset by checking a small number of hashes. This drastically reduces the time taken to authenticate a user as compared to traditional methods that may require a linear search through a database.

Furthermore, the recording of the Merkle Root on the blockchain ensures that any updates to the user list are appended in a time-stamped and immutable manner, providing a clear audit trail. This blockchain-based approach eliminates the delays associated with centralized databases that require synchronization across multiple systems. The decentralized nature of blockchain allows for near real-time updates that are immediately visible across the network, thereby speeding up the process of adding new users and updating their authentication status.

The authentication process itself is expedited by the use of private and public wallet addresses. By encoding the message submitted for authentication with the user's private wallet address, the system leverages the inherent security features of blockchain technology to quickly verify the authenticity of the message without the risk of interception or fraud. This encoding process, combined with the cryptographic security provided by algorithms such as SHA, ensures that the authentication can be performed swiftly and with a high degree of confidence in the security of the transaction.

The facilitation of the authentication process by a mobile application further improves the practical application of the technology. The generation of a Quick Response (QR) code representing the user's wallet address simplifies the user's interaction with the system, allowing for a quick scan and immediate submission of the authentication request. This eliminates the time-consuming step of manually entering data, thereby streamlining the user experience and reducing the overall time taken for authentication.

In summary, the disclosed technology improves upon existing authentication methods by leveraging the speed and security of blockchain technology, the efficiency of Merkle Trees for data verification, and the convenience of mobile applications for user interaction. These technological improvements result in a faster, more secure, and user-friendly authentication process.

According to a further aspect of the present disclosure, a method for novelty detection in natural language processing includes receiving a statement and representing synonyms of words in the statement as nodes in a graph. The nodes are connected by relationships. The method also includes calculating an information content for each pair of adjacent nodes in the graph and determining a novelty of the statement based on a sum of the information content for each pair of nodes.

According to other aspects of the present disclosure, the method may include the relationships between the nodes in the graph being determined based on a trained relationship between word nodes in accordance with a graph-based natural language processing approach. The trained relationship between word nodes may be determined based on a total frequency of observations between adjacent nodes in the graph. The information content for each pair of adjacent nodes in the graph may be calculated using a specific formula. The novelty of the statement may be determined using another specific formula. The statement may be a financial headline or a sports headline.

According to another aspect of the present disclosure, a system for novelty detection in natural language processing includes a processor and a memory storing instructions that, when executed by the processor, cause the processor to perform the method as described above.

According to other aspects of the present disclosure, the system may include the relationships between the nodes in the graph being determined based on a trained relationship between word nodes in accordance with a graph-based natural language processing approach. The trained relationship between word nodes may be determined based on a total frequency of observations between adjacent nodes in the graph. The information content for each pair of adjacent nodes in the graph may be calculated using a specific formula. The novelty of the statement may be determined using another specific formula. The statement may be a financial headline or a sports headline.

According to yet another aspect of the present disclosure, a non-transitory computer-readable medium stores instructions that, when executed by a processor, cause the processor to perform the method as described above. The relationships between the nodes in the graph may be determined based on a trained relationship between word nodes in accordance with a graph-based natural language processing approach. The trained relationship between word nodes may be determined based on a total frequency of observations between adjacent nodes in the graph. The information content for each pair of adjacent nodes in the graph may be calculated using a specific formula. The novelty of the statement may be determined using another specific formula. The statement may be a financial headline.

The disclosed technology represents a technological improvement in the field of natural language processing by introducing a graph-based approach to novelty detection. This method leverages the inherent structure of language, represented as a graph of interconnected synonyms, to assess the novelty of statements with greater efficiency and specificity than traditional deep learning methods.

By calculating the information content for each pair of adjacent nodes in the graph, the system can quantify the degree of novelty in a statement without the extensive computational resources typically associated with training deep neural networks, such as autoencoders. This reduction in computational demand translates to faster processing times and lower operational costs, enabling real-time analysis of language data, which is particularly beneficial for applications requiring immediate insights, such as financial trading or media monitoring.

Moreover, the graph-based approach allows for dynamic updating and scaling. As new data is encountered, the relationships between nodes can be updated, reflecting the evolving use of language. This adaptability ensures that the system remains current with linguistic trends without the complete retraining of a neural network model, thus representing a practical application that is both sustainable and versatile.

The use of a trained relationship between word nodes, based on the frequency of observations in a graph, further refines the novelty detection process. By grounding the relationships in observed linguistic patterns, the system can discern between common language usage and truly novel statements with a high degree of accuracy. This precision is particularly advantageous when analyzing specialized domains, such as financial or sports headlines, where the distinction between routine and novel information can have substantial implications.

In summary, the disclosed technology provides a practical application that improves upon existing natural language processing methods by offering a more resource-efficient, adaptable, and precise system for novelty detection. This represents a substantial technological advancement with wide-ranging applications in various sectors that rely on timely and accurate interpretation of natural language data.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram illustrating a transaction being encoded using a user's private key in accordance with embodiments of the present disclosure.

FIG. 2 is a block diagram illustrating a transaction being decoded on the blockchain with the user's public key in accordance with embodiments of the present disclosure.

FIG. 3 is a block diagram illustrating an example of a Merkle Tree implemented in accordance with embodiments of the present disclosure.

FIG. 4 is a block diagram illustrating an example of a Merkle Proof construction in accordance with embodiments of the present disclosure.

FIG. 5 is a block diagram illustrating an example of a process for adding a new user and updating the blockchain in accordance with embodiments of the present disclosure.

FIG. 6 is a block diagram illustrating an example of a process for authenticating a user in accordance with embodiments of the present disclosure.

FIG. 7 is a block diagram illustrating an example of encoding a user wallet into a QR code using a mobile application in accordance with embodiments of the present disclosure.

FIG. 8 is a block diagram illustrating an example of a process including processing a QR code on a receiver end and creating a function call with the appropriate arguments in accordance with embodiments of the present disclosure.

FIG. 9 is a block diagram illustrating an example of a process including decoding a QR code containing the function call and data required to send to the blockchain and submitting the function call in accordance with embodiments of the present disclosure.

FIG. 10 is a block diagram illustrating an example of a dimensionality in an autoencoder in accordance with embodiments of the present disclosure.

FIG. 11 shows a high-level flow diagram of operation of a system configured for providing functionality for physical authentication using blockchain technologies in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems, methods, and devices for physical authentication using blockchain technologies. In particular, the present disclosure may provide mechanisms for encoding a user list via hashes of respective wallet addresses to construct a Merkle Tree, recording the Merkle Root of the constructed Merkle Tree on the blockchain, updating the Merkle Tree and the Merkle Root each time a user is added to the organization, and authenticating a user by submitting a message to the client, wherein the client creates a Merkle Proof and sends it to the blockchain for authentication.

More specifically, the systems, methods, and devices of the present disclosure may include a user list encoded using a cryptographic hash function, such as a Secure Hash Algorithm (SHA). The user list may be used to construct a Merkle Tree, the Merkle Root of which may be recorded on the blockchain. Each time a user is added to the organization, the Merkle Tree and the Merkle Root may be updated. A user may be authenticated by submitting a message to the client, which may create a Merkle Proof and send it to the blockchain for authentication.

Although the present disclosure focuses on an application for blockchain-based authentication using Merkle Trees, this is intended for illustrative purposes and not by way of limitation. Indeed, in some applications, other techniques for encoding user credentials into a structure (e.g., a tree, a filter, a root, a set, etc.) may be used to generate a structure from a set of user credentials that is then stored on the blockchain. A particular user may be authenticated by checking the particular user credentials against the structure stored on the blockchain. For example, an algorithm particular to the technique used may be used to verify that the particular user credentials are a member of the set of user credentials for which the structure stored on the blockchain was generated. The verification may include decoding the structure and manually checking whether the particular user credentials are in the set of user credentials, may include constructing an algorithmic proof and feeding it to the algorithm to verify the proof against a root stored in the blockchain (e.g., as in a Merkle Tree application), and/or may including determining a probability of the likelihood that the particular user credentials are a member of the set of user credentials for which a filter (e.g., a Bloom filter) stored on the blockchain was generated.

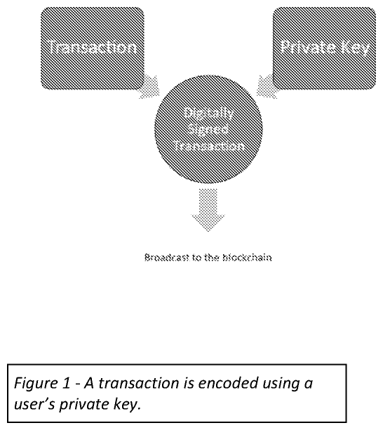

FIG. 1 is a block diagram illustrating a transaction being encoded using a user's private key in accordance with embodiments of the present disclosure. As mentioned above, a user may encode a transaction using their private key may send the encoded transaction to the blockchain for processing.

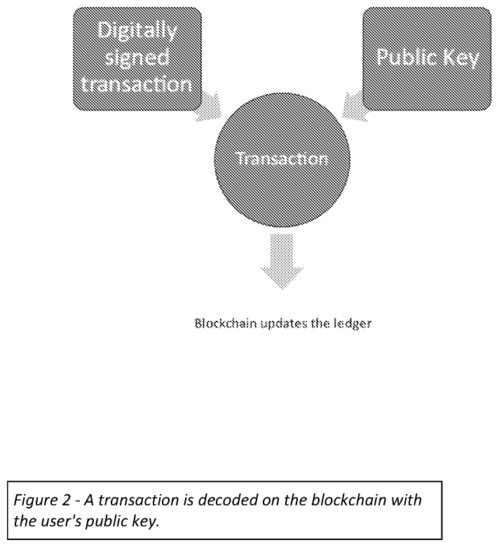

Once the transaction is received by the blockchain, the transaction may be processed by a node in the blockchain in order be fulfilled. The node may decrypt the digitally signed transaction using the user's public key, and may perform blockchain specific validation such as ensuring that the user has enough funds to transfer, or verify that a user has not ‘double spent’ funds. If everything checks out, the ledger is updated accordingly. FIG. 2 is a block diagram illustrating a transaction being decoded on the blockchain with the user's public key in accordance with embodiments of the present disclosure.

The authentication process may be facilitated by a mobile application, which may generate a Quick Response (QR) code representing the user's wallet address. The message submitted by the user for authentication may be encoded using the user's private wallet address. The Merkle Proof may be verified using the user's public wallet address.

The systems, methods, and devices of the present disclosure may offer several benefits. For instance, they may provide a common and interoperable method for authentication that can be leveraged across different organizations. They may also offer data efficiency by encoding user lists extremely efficiently using one-way hashes that minimize storage space. Furthermore, they may provide trustless authentication, ensuring that a message is genuinely from a user by encoding it with the user's private wallet address. Additionally, they may be cost-effective, reducing the costs associated with physical ID cards or other physical objects, and they may offer low latency, benefiting from well-developed hashing algorithms and sub-second transaction times on the blockchain.

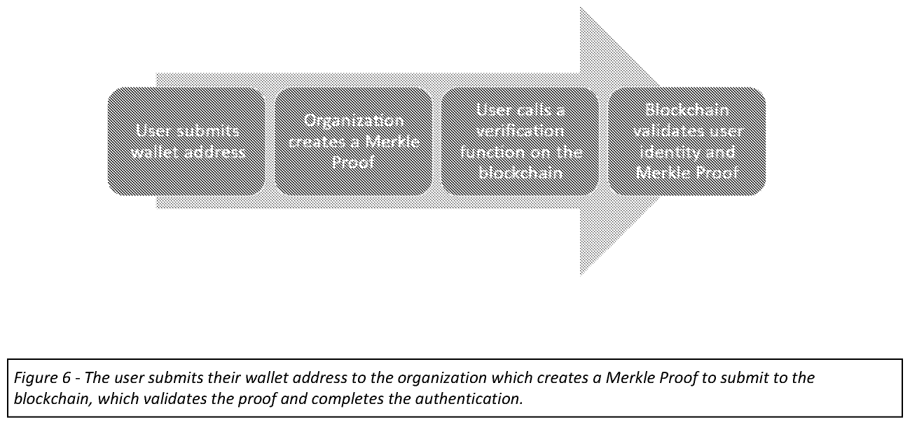

In some aspects, the process of physical authentication using blockchain technologies may include hashing a user's wallet address, and a client creating a Merkle Proof. The wallet hash and the Merkle Proof may be bundled into function arguments for a blockchain function call that the client may submit. On the blockchain side, the Merkle Proof may be verified using the wallet address of the client, the Merkle Proof that was submitted, and the Merkle Root, which may be stored on the blockchain. The results of the verification may be publicly visible on the blockchain to all parties. This process for authenticating a user in accordance with embodiments of the present disclosure is illustrated in FIG. 6.

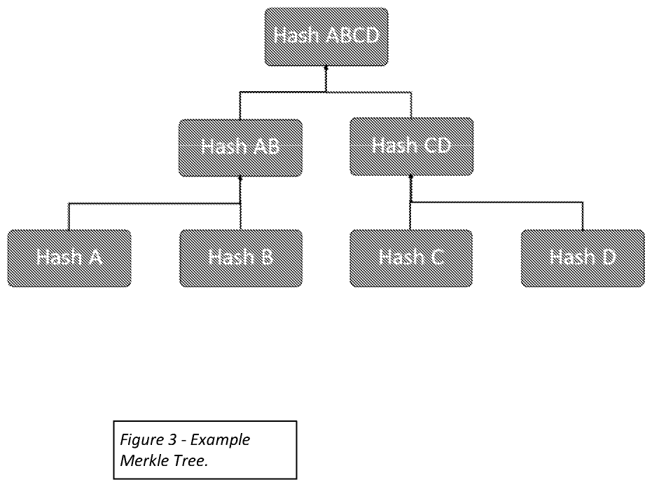

In some aspects, the process of physical authentication using blockchain technologies may involve the encoding of a user list via hashes of respective wallet addresses to construct a Merkle Tree. This Merkle Tree may serve as a data structure that organizes the user list in a manner that is both efficient and secure. FIG. 3 is a block diagram illustrating an example of a Merkle Tree implemented in accordance with embodiments of the present disclosure.

In embodiments, the Merkle Tree may be constructed by hashing each user's wallet address, which may be a public identifier derived from their public cryptographic keys, and organizing these hashes into a tree-like structure.

In some cases, the Merkle Root of the constructed Merkle Tree may be recorded on the blockchain. The Merkle Root may be the topmost node (e.g., the Hash ABCD node) in the Merkle Tree, representing a kind of footprint or summary of all the hashes contained within the tree. By recording the Merkle Root on the blockchain, the organization may create a publicly verifiable record of the user list that is resistant to tampering or fraud.

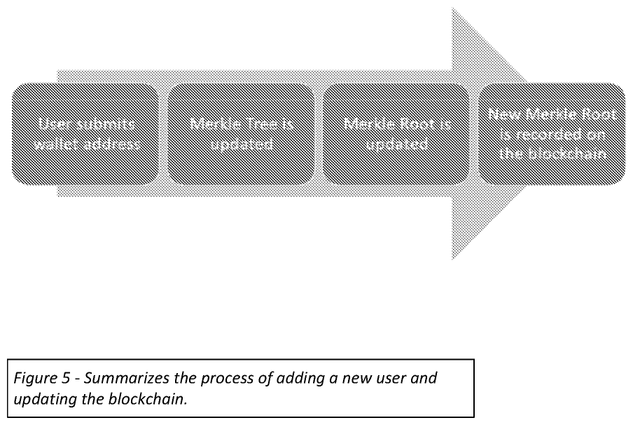

In some embodiments, the Merkle Tree and the Merkle Root may be updated each time a user is added to the organization. This may involve hashing the new user's wallet address, adding this hash to the Merkle Tree, and recalculating the Merkle Root to reflect the updated user list. The updated Merkle Root may then be recorded on the blockchain, ensuring that the blockchain record remains current and accurate. FIG. 5 is a block diagram illustrating an example of a process for adding a new user and updating the Merkle Tree and adding the Merkle Root of the updated Merkle tree on the blockchain in accordance with embodiments of the present disclosure.

In some aspects, a user may be authenticated by submitting a message to the client. The client, in this context, may be a software application or system that interfaces with the blockchain on behalf of the user. The client may create a Merkle Proof based on the user's message and send this Merkle Proof to the blockchain for authentication. The Merkle Proof may be a sequence of hashes that can be used to verify the user's inclusion in the Merkle Tree, and by extension, their membership in the organization.

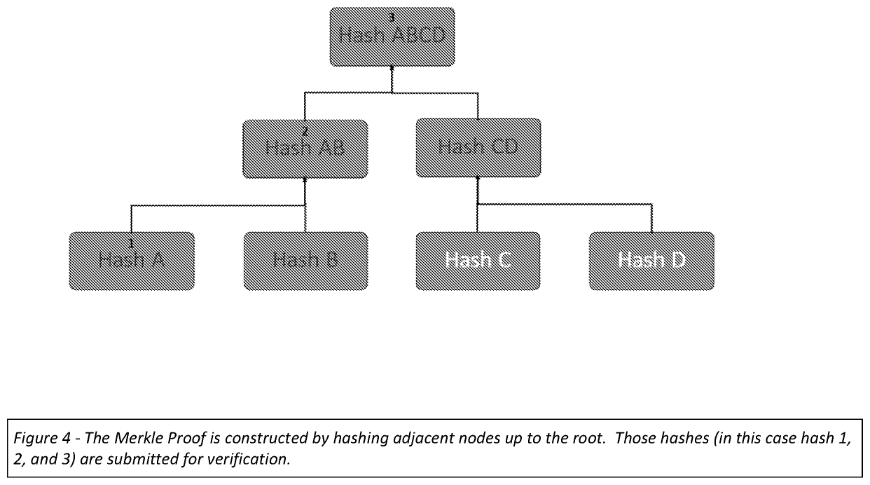

FIG. 4 is a block diagram illustrating an example of a Merkle Proof construction in accordance with embodiments of the present disclosure. As shown, the Merkle Proof may be constructed by hashing adjacent nodes up to the root. Those hashes (in this case hash 1, 2, and 3) may be submitted for verification.

In some cases, the user list may be encoded using a cryptographic hash function. This hash function may transform the user's wallet address into a fixed-size string of characters, which may be used as the basis for constructing the Merkle Tree. The cryptographic hash function may be a Secure Hash Algorithm (SHA) or any other suitable hash function that provides a high level of security and resistance to collisions. The use of a cryptographic hash function may enhance the security of the authentication process by making it computationally infeasible to reverse-engineer the user's wallet address from the hash.

In some embodiments, the process of updating the Merkle Tree and the Merkle Root each time a user is added to the organization may be facilitated. This process may involve encoding the new user's wallet address using a cryptographic hash function, such as a Secure Hash Algorithm (SHA). The SHA may transform the user's wallet address into a fixed-size string of characters, which may be used as the basis for constructing the Merkle Tree. The use of the SHA may enhance the security of the authentication process by making it computationally infeasible to reverse-engineer the user's wallet address from the hash.

Once the new user's wallet address has been hashed, the hash may be added to the Merkle Tree. This may involve inserting the hash into the appropriate position in the tree structure, based on a predetermined ordering or sorting algorithm. The addition of the new hash may necessitate a reorganization of the Merkle Tree to maintain its integrity and balance.

Following the addition of the new hash to the Merkle Tree, the Merkle Root may be recalculated. The Merkle Root, as the topmost node in the Merkle Tree, may represent a kind of footprint or summary of all the hashes contained within the tree. The recalculation of the Merkle Root may involve hashing the hashes of its two child nodes, and repeating this process for each parent node in the tree until the root node is reached.

Once the Merkle Root has been recalculated, it may be recorded on the blockchain. This may involve submitting a transaction to the blockchain that updates the stored Merkle Root with the newly calculated value. The updated Merkle Root may serve as a publicly verifiable record of the current state of the user list, providing a mechanism for authenticating users based on their inclusion in the Merkle Tree.

In some cases, the process of updating the Merkle Tree and the Merkle Root may be automated, such that it is triggered each time a new user is added to the organization. This may involve the use of smart contracts or other automated processes that monitor the user list for changes and initiate the update process when a new user is detected. This automation may ensure that the Merkle Tree and the Merkle Root remain current and accurate, enhancing the reliability and efficiency of the authentication process.

In some aspects, the process of authenticating a user may involve the user submitting a message to the client. The client, which may be a software application or system that interfaces with the blockchain on behalf of the user, may create a Merkle Proof based on the user's message and send this Merkle Proof to the blockchain for authentication. The Merkle Proof may be a sequence of hashes that can be used to verify the user's inclusion in the Merkle Tree, and by extension, their membership in the organization.

In some cases, the message submitted by the user for authentication may be encoded using the user's private wallet address. This private wallet address may be known to the user and used to encode messages to be sent to recipients securely. The encoded message may then be sent to the blockchain for processing. Any third party, malicious or otherwise, would require the user's private wallet address in order to send transactions on their behalf, thereby enhancing the security of the authentication process.

In some embodiments, the Merkle Proof may be verified using the user's public wallet address. The public wallet address, derived from the user's private wallet address, may be used by the recipient to decode the message. Note that a public wallet address can be used by the recipient to decode messages, but it cannot be used to encode messages on behalf of the sender. It is not plausible to reconstruct a private wallet address from its corresponding public wallet address. This feature of the blockchain technology may further enhance the security of the authentication process.

In some aspects, the system may include a mechanism for verifying the Merkle Proof using the user's public wallet address. This mechanism may involve a node in the blockchain decrypting the digitally signed transaction using the user's public wallet address, then performing blockchain specific validation such as ensuring that the user has enough funds to transfer, or verifying that a user has not ‘double spent’ funds. If everything checks out, the ledger may be updated accordingly. This mechanism may provide a robust and secure method for authenticating users, leveraging the distributed nature of the blockchain to ensure every transaction is verified by the blockchain.

In some cases, the method may include a step of verifying the Merkle Proof using the user's public wallet address. This step may involve the client submitting the hash at each level to the blockchain, which verifies each step of the ‘Merkle Proof’. If there is a mismatch at any given point, the proof may be rejected, and authentication may fail. This process may provide a reliable and efficient method for authenticating users, leveraging the functionality of Merkle Trees to efficiently encode data, save space, and reduce or eliminate blockchain fees.

In some embodiments, the user list may be encoded using a cryptographic hash function, such as a Secure Hash Algorithm (SHA). The SHA may be a specific type of cryptographic hash function that transforms the user's wallet address into a fixed-size string of characters. This string of characters, or hash, may be used as the basis for constructing the Merkle Tree. The use of the SHA may enhance the security of the authentication process by making it computationally infeasible to reverse-engineer the user's wallet address from the hash. This may provide a high level of security and resistance to collisions, which are situations where different inputs produce the same hash output.

In some cases, the message submitted by the user for authentication may be encoded using the user's private wallet address. This private wallet address may be a secret identifier known to the user and used to encode messages to be sent to recipients securely. The encoded message may then be sent to the blockchain for processing. Any third party, malicious or otherwise, would require the user's private wallet address in order to send transactions on their behalf. This may enhance the security of the authentication process by ensuring that the user's identity cannot be spoofed or faked.

In some aspects, the message submitted by the user for authentication may be encoded using the user's private wallet address. This private wallet address may be a secret identifier known to the user and used to encode messages to be sent to recipients securely. The encoded message may then be sent to the blockchain for processing. Any third party, malicious or otherwise, would require the user's private wallet address in order to send transactions on their behalf. This may enhance the security of the authentication process by ensuring that the user's identity cannot be spoofed or faked.

In some embodiments, the message submitted by the user for authentication may be encoded using the user's private wallet address. This private wallet address may be a secret identifier known to the user and used to encode messages to be sent to recipients securely. The encoded message may then be sent to the blockchain for processing. Any third party, malicious or otherwise, would require the user's private wallet address in order to send transactions on their behalf. This may enhance the security of the authentication process by ensuring that the user's identity cannot be spoofed or faked.

In some cases, the disclosure may mention the use of a Secure Hash Algorithm (SHA) as a cryptographic hash function for encoding the user list. This specific algorithm may not be mentioned in the claims, but it may be used in some embodiments of the present disclosure. The SHA may be a specific type of cryptographic hash function that transforms the user's wallet address into a fixed-size string of characters. This string of characters, or hash, may be used as the basis for constructing the Merkle Tree. The use of the SHA may enhance the security of the authentication process by making it computationally infeasible to reverse-engineer the user's wallet address from the hash. This may provide a high level of security and resistance to collisions, which are situations where different inputs produce the same hash output.

In some embodiments, the process of authenticating a user may involve verifying the Merkle Proof using the user's public wallet address. The public wallet address, derived from the user's private wallet address, may be used by the recipient to decode the message. The client may submit the hash at each level to the blockchain, which verifies each step of the ‘Merkle Proof’. If there is a mismatch at any given point, the proof may be rejected and authentication may fail. This process may provide a reliable and efficient method for authenticating users, leveraging the functionality of Merkle Trees to efficiently encode data, save space, and reduce or eliminate blockchain fees.

In some cases, the authentication process may be facilitated by a mobile application. The mobile application may interface with the blockchain on behalf of the user, creating a Merkle Proof based on the user's message and sending this Merkle Proof to the blockchain for authentication. The mobile application may provide a user-friendly interface for the user to submit their message, and may handle the technical aspects of creating the Merkle Proof and interacting with the blockchain. This may make the authentication process more accessible and convenient for users, who may not have technical expertise in blockchain technologies.

In some aspects, the system may include a mobile application for facilitating the authentication process. The mobile application may provide a user-friendly interface for the user to submit their message (e.g., including the user's wallet address), and may handle the technical aspects of creating the Merkle Proof and interacting with the blockchain (e.g., may create the function call for submitting the Merkle Proof) to the blockchain. The mobile application may also generate a Quick Response (QR) code representing the user's wallet address.

In aspects, a QR code may be scanned (e.g., by the organization or a receiver) to retrieve the user's wallet address, which may then be used to create the Merkle Proof. This may provide a convenient and secure method for the user to submit their wallet address, without having to manually enter it.

In some embodiments, the authentication process may be facilitated by a mobile application that generates a Quick Response (QR) code representing the user's wallet address. The QR code may be scanned by the organization to retrieve the user's wallet address, which may then be used to create the Merkle Proof. This data may be used to create a function call to the blockchain that the user may submit. This function call may then be encoded into another QR code that the user may scan in the final step. This may provide a convenient and secure method for the user to submit their wallet address, without having to manually enter it. The use of a QR code may also enhance the security of the authentication process, as it may be more difficult for a malicious actor to intercept or spoof a QR code compared to a manually entered wallet address.

In some aspects, the user's message for authentication may be encoded using the user's private wallet address. This private wallet address, known to the user, may be used to encode messages securely. The encoded message may then be sent to the blockchain for processing. Any third party, malicious or otherwise, would require the user's private wallet address in order to send transactions on their behalf. This feature of the blockchain technology may enhance the security of the authentication process by ensuring that the user's identity cannot be spoofed or faked.

In some embodiments, the authentication process may be facilitated by a mobile application. This mobile application may generate a Quick Response (QR) code representing the user's wallet address. The QR code may be displayed on the user's mobile device and scanned by the organization to retrieve the user's wallet address. This process may provide a convenient and secure method for the user to submit their wallet address, without having to manually enter it. The use of a QR code may also enhance the security of the authentication process, as it may be more difficult for a malicious actor to intercept or spoof a QR code compared to a manually entered wallet address.

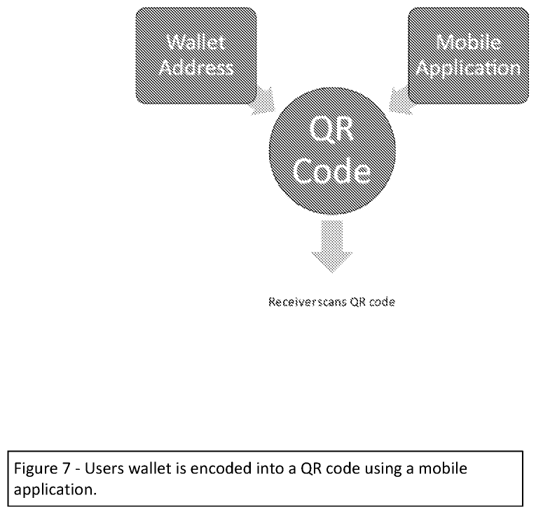

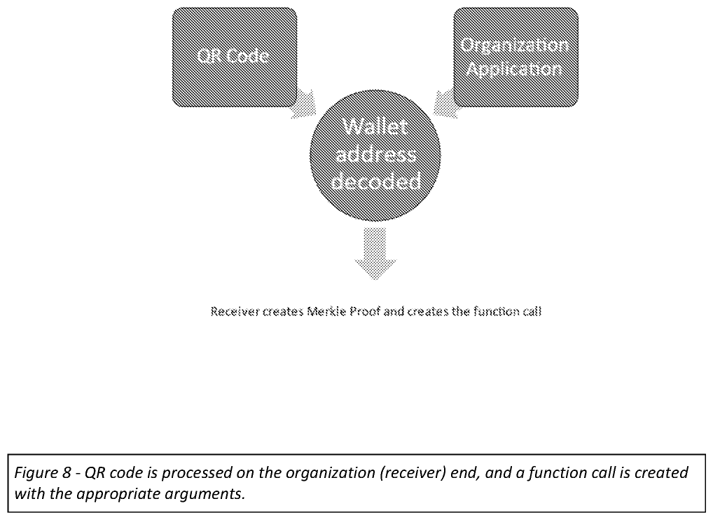

In some cases, the disclosure describes a two-step process for user authentication using QR codes, facilitated by a mobile application. In the first step, the user may submit their wallet address, via a QR code generated by the mobile application, which can be decoded by the organization on the receiving end. This can be displayed on the user's mobile device, and scanned with simple QR scanning technologies, included in modern mobile devices by default, as illustrated in FIG. 7. For example, as illustrated in FIG. 7, a user wallet may be encoded into a QR code using a mobile application. The QR code may be then scanned by the receiver (e.g., by the organization authenticating the user. As illustrated in FIG. 8, the scanned QR code may be processed (e.g., scanned by an application on a computing device associated with the organization or the receiver) to decode the wallet address. Using the Merkle Tree, the organization or receiver may create the Merkle Proof which corresponds to the user's submission (e.g., the decoded user's wallet address). This data is used to create (e.g., by the organization's application) a function call to the blockchain that the user submits. This function call may be encoded into another QR code (e.g., a function call QR code) that the user may scan in the second step.

In the second step, the user may scan the function call QR code from the previous step and the application may use existing communication technology (e.g., Web3 technology) to craft a function call that may be submitted to the blockchain using the user's credentials. The application on the user's end handles this process. Once the transaction is sent to the blockchain, all parties can see the result, if the authentication was successful or not. This two-step process may provide a seamless and user-friendly experience for the user while maintaining a high level of security.

In some embodiments, the authentication process may be facilitated by a mobile application. This mobile application may serve as an interface between the user and the blockchain, handling the technical aspects of creating the Merkle Proof and interacting with the blockchain. The mobile application may provide a user-friendly interface for the user to submit their message, and may handle the technical aspects of creating the Merkle Proof and interacting with the blockchain. This may make the authentication process more accessible and convenient for users, who may not have technical expertise in blockchain technologies.

In some cases, the mobile application may generate a Quick Response (QR) code representing the user's wallet address. The QR code may be displayed on the user's mobile device and scanned by the organization to retrieve the user's wallet address. This process may provide a convenient and secure method for the user to submit their wallet address, without having to manually enter it. The use of a QR code may also enhance the security of the authentication process, as it may be more difficult for a malicious actor to intercept or spoof a QR code compared to a manually entered wallet address.

In some aspects, the disclosure describes a two-step process for user authentication using QR codes, facilitated by a mobile application. In the first step, the user may submit their wallet address, via a QR code generated by the mobile application, which can be decoded by the organization on the receiving end. This can be displayed on the user's mobile device, and scanned with simple QR scanning technologies, included in modern mobile devices by default.

In the second step, the QR code is decoded by the application on the receiver's (organization's) end. Using the Merkle Tree, the organization creates the Merkle Proof which corresponds to the user's submission (their wallet address). This data is used to create a function call to the blockchain that the user submits. This function call is then encoded into another QR code that the user may scan in the final step. The user scans the QR code from the previous step and the application uses existing Web3 technology to craft a function call that may be submitted to the blockchain using the user's credentials. The application on the user's end handles this process. Once the transaction is sent to the blockchain, all parties can see the result, if the authentication was successful or not. This two-step process may provide a seamless and user-friendly experience for the user while maintaining a high level of security.

In some embodiments, the authentication process may be facilitated by existing scanner systems and may be standardized across organizations. This may involve the use of standard QR scanning technologies, which are included in modern mobile devices by default. This standardization may make the authentication process more accessible and convenient for users, as they may not have to purchase specialized scanners or proprietary software solutions. This may also reduce the costs associated with the authentication process, as organizations may not have to invest in bespoke, proprietary, or third-party implementations.

In some aspects, the process of user authentication may involve a two-step process facilitated by a mobile application. The mobile application may generate a Quick Response (QR) code representing the user's wallet address. The QR code may be displayed on the user's mobile device and scanned by the organization to retrieve the user's wallet address. This process may provide a convenient and secure method for the user to submit their wallet address, without having to manually enter it. The use of a QR code may also enhance the security of the authentication process, as it may be more difficult for a malicious actor to intercept or spoof a QR code compared to a manually entered wallet address.

In the first step of the authentication process, the user may submit their wallet address via a QR code generated by the mobile application. This QR code can be decoded by the organization on the receiving end. This can be displayed on the user's mobile device, and scanned with simple QR scanning technologies, included in modern mobile devices by default.

In the second step, the QR code is decoded by the application on the receiver's (organization's) end. Using the Merkle Tree, the organization creates the Merkle Proof which corresponds to the user's submission (their wallet address). This data is used to create a function call to the blockchain that the user submits. This function call is then encoded into another QR code that the user may scan in the final step.

The user scans the QR code from the previous step and the application uses existing Web3 technology to craft a function call that may be submitted to the blockchain using the user's credentials. The application on the user's end handles this process. Once the transaction is sent to the blockchain, all parties can see the result, if the authentication was successful or not. This two-step process may provide a seamless and user-friendly experience for the user while maintaining a high level of security.

In some cases, the disclosure mentions the possibility of marking up the transaction cost to include a small fee as compensation for the organization's efforts. This potential revenue model may be implemented in some embodiments of the present disclosure. The cost of the operations may be reduced to the cost of the transaction submitted by the user to the blockchain which is nominal on modern blockchains. Note that the organization could mark-up this transaction cost to include a small fee, negligible in the individual sense, but considerable en masse. This could provide a potential revenue stream for the organization, offsetting the costs associated with maintaining the authentication system.

In some embodiments, the process of user authentication may involve a transaction submitted by the user to the blockchain. This transaction may be associated with a cost, known as a “gas fee,” which is typically nominal on modern blockchains. However, in some cases, the organization facilitating the authentication process may choose to mark up this transaction cost to include a small fee as compensation for their efforts. This fee may be negligible on an individual basis, but when aggregated across a large user base, it could represent a substantial revenue stream for the organization.

This potential revenue model may provide a financial incentive for organizations to adopt the authentication system described herein. By marking up the transaction cost, the organization may be able to offset the costs associated with maintaining the authentication system, including the costs of updating the Merkle Tree and the Merkle Root, processing user messages, and interacting with the blockchain. This could make the authentication system more economically viable for organizations, particularly those with large user bases.

Moreover, the use of a markup on the transaction cost may also provide a mechanism for the organization to recover the costs associated with any potential blockchain fees. As mentioned earlier, storing data on the blockchain can be expensive, and while the use of Merkle Trees can mitigate these costs by efficiently encoding data, there may still be some costs associated with writing data to the blockchain. By including a small fee in the transaction cost, the organization may be able to recover these costs, further enhancing the economic viability of the authentication system.

It is worth noting that the inclusion of a small fee in the transaction cost is not a mandatory feature of the authentication system described herein. In some cases, the organization may choose not to mark up the transaction cost, or may choose to mark it up by a different amount. The decision to include a fee, and the amount of that fee, may be determined by the organization based on a variety of factors, including the costs associated with maintaining the authentication system, the size of the user base, and the organization's financial objectives.

In some embodiments, the implementation of the authentication process may leverage existing scanner systems and may be standardized across different organizations. This standardization may provide a common strategy for organizations, reducing the reliance on various bespoke, proprietary, or third-party implementations. The use of existing scanner systems, such as those capable of reading QR codes, may be advantageous as these systems are often included in modern mobile devices by default. This may eliminate the potential costs and complexities associated with the procurement and integration of specialized scanning hardware.

The standardization across organizations may also facilitate interoperability, allowing users to leverage the same authentication process across multiple organizations. This may enhance the user experience by providing a consistent and familiar authentication process, regardless of the organization or resource being accessed. Furthermore, standardization may simplify the management and maintenance of the authentication system for organizations, as they may not have to deal with the complexities of managing multiple, disparate authentication mechanisms.

In some cases, the standardization may involve the use of common protocols or standards for generating and reading QR codes. These common protocols or standards may ensure that the QR codes generated by the mobile application are compatible with the scanning systems used by different organizations. This may further enhance the interoperability of the authentication system, allowing users to use the same mobile application and QR code-based authentication process across multiple organizations.

In some aspects, the use of existing scanner systems and standardization across organizations may be incorporated in some embodiments of the present disclosure. The choice of scanner systems and the degree of standardization may be determined by the organization based on a variety of factors, including the available hardware and software resources, the specific requirements of the authentication process, and the organization's operational and financial objectives.

In some embodiments, the system may offer environmental benefits, particularly in terms of reducing the use of plastic ID cards or fobs. Traditional physical authentication mechanisms often rely on the use of plastic ID cards or fobs, which can contribute to environmental pollution when they are discarded or lost. These plastic items are typically made from non-biodegradable materials and can take hundreds of years to decompose in the environment, leading to long-term environmental harm.

In contrast, the system described herein may alleviate the reliance on such physical objects for authentication. Instead, the system may leverage digital technologies, such as blockchain and QR codes, to authenticate users. This digital approach to authentication may eliminate the production and disposal of plastic ID cards or fobs, thereby reducing the environmental impact associated with these items.

In some cases, the user's mobile device may serve as the primary physical device for authentication. The mobile device may display a QR code that can be scanned by the organization to retrieve the user's wallet address. This process may not require the production of any additional physical objects, as the user's mobile device and the organization's scanning system may already exist. This may further reduce the environmental impact of the authentication process.

In some aspects, the reduction in the use of plastic ID cards or fobs provides an environmental benefit that may be inherent in some embodiments of the present disclosure. The degree to which the system reduces the use of plastic ID cards or fobs may depend on a variety of factors, including the specific implementation of the system, the number of users, and the frequency of authentication events. Regardless, the potential for environmental benefits may be an advantageous feature of the system, contributing to its appeal for organizations seeking to reduce their environmental footprint.

A number of implementations have been described. Nevertheless, it will be understood that various modifications may be made without departing from the spirit and scope of the disclosure. Accordingly, other implementations are within the scope of the present disclosure.

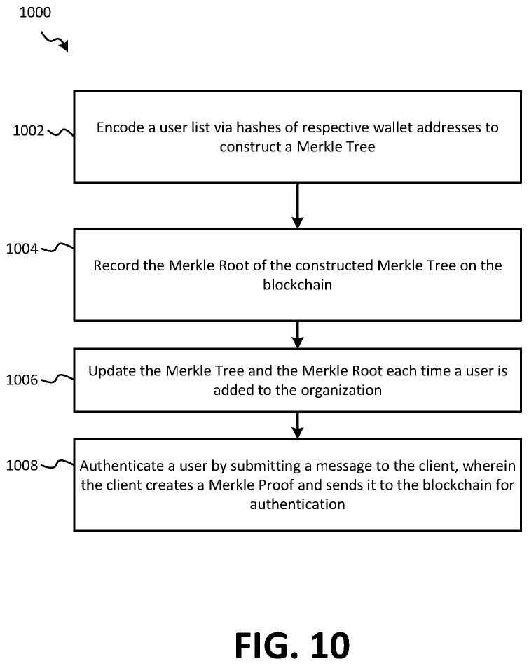

FIG. 10 shows a high-level flow diagram 1000 of operation of a system configured for providing functionality for physical authentication using blockchain technologies in accordance with embodiments of the present disclosure. For example, the functions illustrated in the example blocks shown in FIG. 10 may be performed by a system implemented according to embodiments herein. In embodiments, the operations of the method 1000 may be stored as instructions (e.g., machine-readable instructions) that, when executed by one or more processors of a computing system (e.g., of a server, cloud-based system, computer system (such as PC, laptop, mobile device, tablet, etc.), etc.), cause the one or more processors to perform the operations of the method 1000.

In embodiments, the one or more processors operably coupled to a memory and may be capable of executing the machine-readable instructions to perform program steps (e.g., including each of the steps of flow diagram 1000, and/or steps according to any functionality described in this description). In embodiments, execution of the machine-readable instructions to perform the program steps may include spawning a plurality of concurrent computer processes, each of the of the concurrent computer processes configured to process at least a portion of the machine-readable instructions to increase the speed of the performance of the instructions and/or program steps. Increasing the speed of at which computer processors are able to execute instructions results in an improvement in the functioning of the one or more processor and/or the computing system, and thus, represent a practical application.

At block 1002, a user list is encoded via hashes of respective wallet addresses to construct a Merkle Tree. In embodiments, functionality of a computing system may be used to encode a user list via hashes of respective wallet addresses to construct a Merkle Tree according to operations and functionality as described above.

At block 1004, the Merkle Root of the constructed Merkle Tree is recorded on the blockchain. In embodiments, functionality of a computing system may be used to record the Merkle Root of the constructed Merkle Tree on the blockchain according to operations and functionality as described above.

At block 1006, the Merkle Tree and the Merkle Root are updated each time a user is added to the organization. In embodiments, functionality of a computing system may be used to update the Merkle Tree and the Merkle Root each time a user is added to the organization according to operations and functionality as described above.

At block 1008, a user is authenticated by submitting a message to the client, wherein the client creates a Merkle Proof and sends it to the blockchain for authentication. In embodiments, functionality of a computing system may be used to authenticate a user by submitting a message to the client according to operations and functionality as described above.

The present disclosure additionally, or alternatively, relates to systems and methods for novelty detection in natural language processing. In some aspects, the present disclosure provides a graph-based approach for determining the novelty of information in statements, such as financial or sports headlines. This approach may involve representing synonyms of words in a given statement as nodes in a graph, where the nodes are connected by relationships. The novelty of the statement may then be determined based on the sum of the information content for each pair of nodes in the graph.

More specifically, the systems and methods of the present disclosure may calculate the information content for each pair of adjacent nodes in the graph using a specific formula. This formula may involve the use of the relationship between the nodes, which may be determined based on a trained relationship between word nodes in accordance with a graph-based natural language processing approach. The novelty of the statement may then be determined using another formula, which involves the sum of the information content for each pair of nodes.

In embodiments, novelty, in the context of linguistic statements, may include statements that possess higher informational content compared to others within a specified set. It is important to distinguish between novelty and importance, as these are separate concepts. For instance, consider the statements “S&P downgrades <Company X>” and “Core CPI exceeds expectations by 0.1%.” Both statements may be significant or important. In the case of multiple downgrades, investors, justifiably, might predict an economic downturn, leading them to adopt more risk-averse strategies. Additionally, the CPI is a key metric for the Federal Reserve, influencing their decisions on interest rate adjustments and providing guidance on future economic policies. Nevertheless, such statements are not novel and would not be considered as such in any comprehensive training set of financial headlines.

However, consider the headlines “China's Evergrande has defaulted on its debt” and “Elon Musk announces he is buying Twitter.” Although these statements may seem commonplace in recent times, these statements initially surprised the market upon release. Each statement influenced the market for different reasons, demonstrating that they were not only novel but also important. Contrast this with a sports headline such as “Tampa Bay Lightning going for fourth straight win.” While an ML model may consider this statement novel if the model was trained primarily on financial headlines, such as statement would unlikely have a significant impact on the market.

A graph-based approach was disclosed in U.S. patent application Ser. No. 18/475,159 (hereinafter “the '159 Application”) filed on Sep. 26, 2023, titled “SYSTEMS AND METHODS FOR SENTIMENT EXTRACTION IN NATURAL LANGUAGE PROCESSING BASED ON GRAPH-BASED MODELS, AND INDICATORS FOR TRADING PLATFORMS,” the entirety of which is incorporated herein by reference for all purposes. The graph-based approach disclosed therein may offer a solution to determining novelty which offers advantages to the autoencoder method described above. As noted, synonyms of words, comprising a given statement may be represented by nodes connected by relationships. Embedded in the relationships may be observable qualities such as sentiment, importance, or a subject. The sum of the path in a graph formed by the relationships of each subsequent pair of nodes in a statement may result in a measurement which may allow a system to infer characteristics from such a graphical representation.

The graph-based approach of the present disclosure offers several potential advantages. For instance, it may allow for the use of an existing natural language processing graph, thereby potentially reducing the computational expense and cost associated with training a new neural network. Furthermore, the graph-based approach may provide an associative approach to natural language processing, which may offer advantages over other methods that transform words in an input statement into vectors. As such, the systems and methods of the present disclosure may provide a more efficient and effective way of detecting novelty in natural language processing.

In some cases, the novelty detection process begins with receiving a statement. The statement may be any sequence of words or phrases that convey a particular meaning or information. For example, the statement could be a financial headline, a sports headline, or any other type of text data. The statement is then processed to identify the words within it. In some aspects, the words in the statement may be represented as nodes in a graph. Each node in the graph may correspond to a synonym of a word in the statement.

In some cases, the nodes in the graph are connected by relationships. These relationships may be determined based on a trained relationship between word nodes in accordance with a graph-based natural language processing approach. The trained relationship between word nodes may be determined based on a total frequency of observations between adjacent nodes in the graph. In other words, the frequency with which two words (or their synonyms) appear adjacent to each other in a training set of statements may determine the strength or weight of the relationship between their corresponding nodes in the graph.

In some aspects, the information content for each pair of adjacent nodes in the graph is calculated. The information content may be calculated using Equation 1, for example.

$$I [ R \{ {N}_{i} , {N}_{i + 1} \} ] = - log p ( R \{ {N}_{i} , {N}_{i + 1} \} ) , \qquad ( Equation 1 )$$

where I is the information content, Nᵢ and Nᵢ₊₁ are adjacent nodes in the graph corresponding to the synonym equivalence classes of the adjacent words in the input statement.

In embodiments, the relationship between Nᵢ and Nᵢ₊₁ may be denoted by R{Nᵢ, Nᵢ₊₁}. The probability, p(R{Nᵢ, Nᵢ₊₁}), may be calculated using the trained relationships between word nodes, as disclosed in the '159 Application. However, whereas in the '159 Application this relationship was broken down into components corresponding to characteristics like risk sentiment values or importance of the statemen, in the present disclosure the relationship R{Nᵢ, Nᵢ₊₁} may denote the total frequency of observations between Nᵢ and Nᵢ₊₁.

In aspects, the indexing between, +1 herein may be replaced by some Δx in more advanced calculations. In other words, the present disclosure is not limited to adjacent nodes, but may instead rely on a weighted sum of different offsets.

In aspects, the novelty of a statement may be determined based on a sum of the information content for each pair of nodes. This may be calculated using Equation 2 below.

$$v \{ {N}_{j} \} = {\sum }_{i = 0}^{M - 1} I [ R \{ {N}_{i} , {N}_{i + 1} \} ] , \qquad ( Equation 2 )$$

where the novelty, v of a sequence of nodes {Nⱼ}, which correspond to the nodes of graph representation of a particular statement, is given by the sum of the information content as defined above.

In some cases, the novelty detection process may be performed by a system comprising a processor and a memory storing instructions that, when executed by the processor, cause the processor to perform the steps of the process. In other cases, the novelty detection process may be embodied in a non-transitory computer-readable medium storing instructions that, when executed by a processor, cause the processor to perform the steps of the process.

In some aspects, the relationships between the nodes in the graph may be determined based on a trained relationship between word nodes. This trained relationship may be in accordance with a graph-based natural language processing approach. The trained relationship between word nodes may be determined based on a total frequency of observations between adjacent nodes in the graph. In other words, the frequency with which two words (or their synonyms) appear adjacent to each other in a training set of statements may determine the strength or weight of the relationship between their corresponding nodes in the graph.

In some cases, the trained relationship between word nodes may be determined based on a total frequency of observations between adjacent nodes in the graph. This frequency may be calculated from a training set of statements, where each statement is a sequence of words or phrases. The training set of statements may be used to configure the weights of the relationships in the graph, thereby allowing the graph to represent the training set. For example, if the training set consists of financial headlines, then the graph may be configured to represent financial language.

In some aspects, the trained relationship between word nodes may be determined based on a total frequency of observations between adjacent nodes in the graph. This approach may allow for the use of an existing natural language processing graph, thereby potentially reducing the computational expense and cost associated with training a new neural network. Furthermore, this approach may provide an associative approach to natural language processing, which may offer advantages over other methods that transform words in an input statement into vectors.

In some cases, the trained relationship between word nodes may be determined based on a total frequency of observations between adjacent nodes in the graph. This approach may allow for the use of an existing natural language processing graph, thereby potentially reducing the computational expense and cost associated with training a new neural network. Furthermore, this approach may provide an associative approach to natural language processing, which may offer advantages over other methods that transform words in an input statement into vectors.

In some aspects, the trained relationship between word nodes may be determined based on a total frequency of observations between adjacent nodes in the graph. This approach may allow for the use of an existing natural language processing graph, thereby potentially reducing the computational expense and cost associated with training a new neural network. Furthermore, this approach may provide an associative approach to natural language processing, which may offer advantages over other methods that transform words in an input statement into vectors.

In some aspects, the calculation of the information content for each pair of adjacent nodes in the graph may be performed using a specific formula. This formula may be expressed as Equation 1 above. In this context, this relationship denotes the total frequency of observations between Nᵢ and Nᵢ₊₁, rather than being broken down into components corresponding to characteristics, like risk sentiment values or the perceived relevance of the statement.

In some cases, the calculation of information content may not be limited to adjacent nodes in the graph. Instead, the calculation may be extended to non-adjacent nodes using a weighted sum of different offsets. This means that the indexing between nodes, which is +1 in the case of adjacent nodes, may be replaced by some Δx in more advanced calculations. In other words, the systems and methods of the present disclosure are not limited to calculating the information content for adjacent nodes, but could take a weighted sum of the information content for nodes that are offset by different amounts. This flexibility in the calculation of information content may provide a more nuanced and comprehensive measure of the novelty of a statement, as it allows for the consideration of relationships between non-adjacent words in the statement.

In some aspects, the novelty of the statement may be determined using a formula that involves summing the information content for each pair of nodes. This formula may be expressed as Equation 2 above. The sum of the information content, as defined in this formula, is the sum of the information content for each pair of nodes.

In some cases, the novelty of the statement may be determined using a similar formula, but with a different operational interpretation. For instance, the formula represented in Equation 2 may be used, and the sum of the information content in this case may be defined as the sum of the information content for each pair of nodes, but the calculation may be performed in a different operational context or using a different computational approach.

In some aspects, the novelty of the statement may be determined using a process that involves summing the information content for each pair of nodes. This process may be represented by the formula represented in Equation 2. The sum of the information content in this case is defined as the sum of the information content for each pair of nodes. This process-based approach to determining the novelty of a statement may provide a more dynamic and flexible way of assessing novelty, as it allows for the possibility of incorporating additional computational steps or adjustments into the process.

In some aspects, the method for novelty detection may be applied to different types of statements. For instance, the statement may be a financial headline. Financial headlines often contain information that is of interest to investors, traders, and other financial market participants. By applying the novelty detection method to financial headlines, it may be possible to identify novel information that could potentially have an impact on financial markets. For example, a financial headline such as “Company X announces a breakthrough in technology Y” may be considered novel if the relationship between the nodes representing “Company X”, “announces”, “breakthrough”, “in”, “technology”, and “Y” in the graph has a high information content. This could indicate that the headline contains new information that is not commonly seen in the training set of financial headlines.

In other cases, the statement may be a sports headline. Sports headlines often contain information about games, players, teams, and other sports-related topics. By applying the novelty detection method to sports headlines, it may be possible to identify novel information that could be of interest to sports fans, analysts, and other sports enthusiasts. For example, a sports headline such as “Team A signs player B from Team C” may be considered novel if the relationship between the nodes representing “Team A”, “signs”, “player B”, “from”, and “Team C” in the graph has a high information content. This could indicate that the headline contains new information that is not commonly seen in the training set of sports headlines.

In some aspects, the novelty detection method may be applied to other types of statements beyond financial and sports headlines. For example, the statement could be a news headline, a social media post, a scientific article, a legal document, or any other type of text data. By applying the novelty detection method to these different types of statements, it may be possible to identify novel information in a wide range of domains and contexts. This flexibility in the application of the novelty detection method may enhance its utility and effectiveness in various natural language processing tasks.

In some aspects, the systems and methods of the present disclosure may leverage an existing natural language processing (NLP) graph for novelty detection. This approach may offer several potential advantages over traditional methods that require the construction and training of a new deep neural network (DNN). For instance, the use of an existing NLP graph may reduce the computational expense and cost associated with training a new DNN. This is because the weights of the relationships in the graph, which are configured based on a training set of statements, may already be optimized to represent the subject matter of the training set. As such, there may be no additional training or tuning of hyperparameters, which are typically associated with DNNs, that is necessitated.

Furthermore, the use of an existing NLP graph may allow for the repurposing of an existing resource, thereby potentially enhancing the efficiency of the novelty detection process. For example, if an NLP graph has already been trained for a particular task, such as sentiment analysis, it may be possible to overlay the novelty detection formula on the existing graph, thereby repurposing the graph for novelty detection. This approach may avoid the potential difficulties and costs associated with recycling and repurposing a DNN for novelty detection.

In some cases, the existing NLP graph may be used to calculate the information content for each pair of adjacent nodes in the graph. This calculation may be performed using a specific formula, such as Equation 1 above. In these cases, probability, p(R{Nᵢ, Nᵢ₊₁}), may be calculated using the trained relationships between word nodes, in accordance with the graph-based NLP approach. In this case, this relationship denotes the total frequency of observations between N; and Nᵢ₊₁, rather than being broken down into components corresponding to characteristics, like risk sentiment values or the perceived relevance of the statement.

In some aspects, the novelty of the statement may be determined based on a sum of the information content for each pair of nodes. This may be calculated using a formula such as Equation 2 above. This approach to determining the novelty of a statement may provide a more efficient and effective way of detecting novelty in natural language processing, as it leverages the existing structure and relationships of the NLP graph.

A number of implementations have been described. Nevertheless, it will be understood that various modifications may be made without departing from the spirit and scope of the disclosure. Accordingly, other implementations are within the scope of the present disclosure.

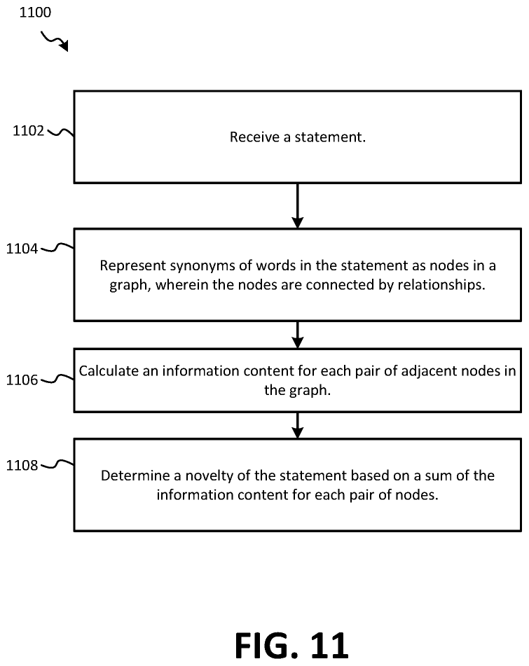

FIG. 11 shows a high-level flow diagram 1100 of operation of a system configured for providing functionality for determining the novelty of a statement using a graph-based NLO approach in accordance with embodiments of the present disclosure. For example, the functions illustrated in the example blocks shown in FIG. 11 may be performed by a system implemented according to embodiments herein. In embodiments, the operations of the method 1100 may be stored as instructions (e.g., machine-readable instructions) that, when executed by one or more processors of a computing system (e.g., of a server, cloud-based system, computer system (such as PC, laptop, mobile device, tablet, etc.), etc.), cause the one or more processors to perform the operations of the method 1100.

In embodiments, the one or more processors operably coupled to a memory and may be capable of executing the machine-readable instructions to perform program steps (e.g., including each of the steps of flow diagram 1100, and/or steps according to any functionality described in this description). In embodiments, execution of the machine-readable instructions to perform the program steps may include spawning a plurality of concurrent computer processes, each of the of the concurrent computer processes configured to process at least a portion of the machine-readable instructions to increase the speed of the performance of the instructions and/or program steps. Increasing the speed of at which computer processors are able to execute instructions results in an improvement in the functioning of the one or more processor and/or the computing system, and thus, represent a practical application.

At block 1102, a statement is received. In embodiments, functionality of a computing system may be used to receive a statement according to operations and functionality as described above.

At block 1104, synonyms of words in the statement are represented as nodes in a graph, wherein the nodes are connected by relationships. In embodiments, functionality of a computing system may be used to represent synonyms of words in the statement as nodes in a graph according to operations and functionality as described above.

At block 1106, an information content is calculated for each pair of adjacent nodes in the graph. In embodiments, functionality of a computing system may be used to calculate an information content for each pair of adjacent nodes in the graph according to operations and functionality as described above.

At block 1108, a novelty of the statement is determined based on a sum of the information content for each pair of nodes. In embodiments, functionality of a computing system may be used to determine a novelty of the statement based on a sum of the information content for each pair of nodes according to operations and functionality as described above.

In embodiments, the relationships between the nodes in the graph may be determined based on a trained relationship between word nodes in accordance with a graph-based natural language processing approach.

In embodiments, the trained relationship between word nodes may be determined based on a total frequency of observations between adjacent nodes in the graph.

In embodiments, the information content for each pair of adjacent nodes in the graph may be calculated using Equation 1 above. In embodiments, the novelty of the statement may be determined using Equation 2 above.

In embodiments, the statement may be one or more of a financial headline, a sports headline, etc.

In embodiments, a system for novelty detection in natural language processing may be provided. The system may include one or more processors, and a memory coupled to the one or more processors. The memory may store instructions that, when executed by the processor, cause the processor to perform steps as in flow diagram 1100.

In embodiments, a non-transitory computer-readable medium may be provided. The non-transitory computer-readable medium may store instructions that, when executed by a processor, cause the processor to perform a method for novelty detection in natural language processing including steps of flow diagram 1100.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

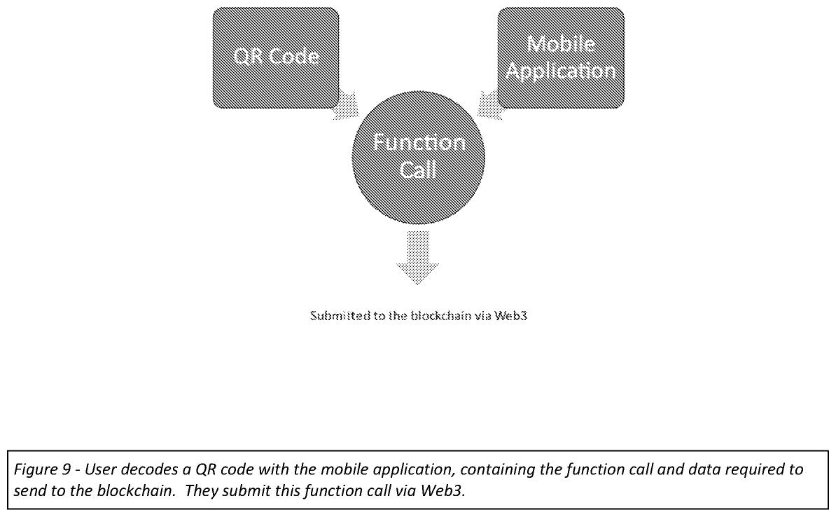

Functional blocks and modules in FIGS. 1-11 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for physical authentication using blockchain technologies, comprising:
encoding a user list via hashes of respective wallet addresses to construct a Merkle Tree;
recording the Merkle Root of the constructed Merkle Tree on the blockchain;
updating the Merkle Tree and the Merkle Root each time a user is added to the organization; and
authenticating a user by submitting a message to the client, wherein the client creates a Merkle Proof and sends it to the blockchain for authentication.

2. The method of claim 1, wherein the user list is encoded using a cryptographic hash function.

3. The method of claim 2, wherein the cryptographic hash function is a Secure Hash Algorithm (SHA).

4. The method of claim 1, further comprising the step of verifying the Merkle Proof using the user's public wallet address.

5. The method of claim 1, wherein the message submitted by the user for authentication is encoded using the user's private wallet address.

6. The method of claim 1, wherein the authentication process is facilitated by a mobile application.

7. The method of claim 6, wherein the mobile application generates a Quick Response (QR) code representing the user's wallet address.

8. A system for physical authentication using blockchain technologies, comprising:
a user list encoded via hashes of respective wallet addresses to construct a Merkle Tree;
a Merkle Root of the constructed Merkle Tree recorded on the blockchain;
a mechanism for updating the Merkle Tree and the Merkle Root each time a user is added to the organization; and
a mechanism for authenticating a user by submitting a message to the client, wherein the client creates a Merkle Proof and sends it to the blockchain for authentication.

9. The system of claim 8, wherein the user list is encoded using a cryptographic hash function.

10. The system of claim 9, wherein the cryptographic hash function is a Secure Hash Algorithm (SHA).

11. The system of claim 8, further comprising a mechanism for verifying the Merkle Proof using the user's public wallet address.

12. The system of claim 8, wherein the message submitted by the user for authentication is encoded using the user's private wallet address.

13. The system of claim 8, further comprising a mobile application for facilitating the authentication process.

14. The system of claim 13, wherein the mobile application generates a Quick Response (QR) code representing the user's wallet address.

15. A computer-implemented method for physical authentication using blockchain technologies, comprising:
encoding a user list via hashes of respective wallet addresses to construct a Merkle Tree;
recording the Merkle Root of the constructed Merkle Tree on the blockchain;
updating the Merkle Tree and the Merkle Root each time a user is added to the organization; and
authenticating a user by submitting a message to the client, wherein the client creates a Merkle Proof and sends it to the blockchain for authentication.

16. The method of claim 15, wherein the user list is encoded using a cryptographic hash function.

17. The method of claim 16, wherein the cryptographic hash function is a Secure Hash Algorithm (SHA).

18. The method of claim 15, further comprising the step of verifying the Merkle Proof using the user's public wallet address.

19. The method of claim 15, wherein the message submitted by the user for authentication is encoded using the user's private wallet address.

20. The method of claim 15, wherein the authentication process is facilitated by a mobile application that generates a Quick Response (QR) code representing the user's wallet address.
